(19) United States
(12) Patent Application Publication
(10) Pub. No.: US 2020/0005661 A1
(43) Pub. Date: Jan. 2, 2020

(54) PHONIC FIRES TRAINER

(71) Applicant: Cubic Corporation, San Diego, CA (US)

(72) Inventors: Martyn Armstrong, Salisbury (GB); Neale Smiles, Salisbury (GB); Alastair Parkinson, Salisbury (GB); Robert Spriggs, Melksham (GB); Jason Mayo, Medstead (GB); Karl Post, Garden Grove, CA (US)

(73) Assignee: Cubic Corporation, San Diego, CA (US)

(21) Appl. No.: 16/448,322

(22) Filed: Jun. 21, 2019

Related U.S. Application Data
(60) Provisional application No. 62/690,664, filed on Jun. 27, 2018.

(51) Int. Cl. G09B 9/00; G10L 15/22; G10L 15/26

(52) U.S. Cl. CPC G09B 9/003; G10L 2015/223; G10L 15/265; G10L 15/22

(57) ABSTRACT

A voice-controlled training unit for conducting fire training and/or operation of an artillery unit may include a communication interface, a memory, and a processing unit communicatively coupled with the communication interface and the memory. The processing unit may be configured to cause the voice-controlled training unit to detect spoken speech, and to determine that the spoken speech includes a command that is related to operation of the artillery unit. The processing unit may be further configured to cause the voice-controlled training unit to generate a message indicative of the command, in accordance with a protocol of a distributed computer simulation standard, and send, via the communication interface, the message indicative of the command to a remote simulation system.

### CROSS-REFERENCES TO RELATED APPLICATIONS

The application claims the benefit of U.S. Provisional Application No. 62/690,664, filed on Jun. 27, 2018, entitled “Phonic Fires Trainer,” which is incorporated by reference herein in its entirety.

### BACKGROUND

In traditional training environments, artillery training (e.g., training involving guns, rockets, and mortars) can involve verbal communication among multiple entities. This verbal communication often includes words and phrases from “Fire Discipline,” a type of standardized verbal communication for artillery, which may be defined and/or described in a North Atlantic Treaty Organization (NATO) Standardization Agreement (STANAG) or similar document (e.g., the Field Manual (FM) 3-09 publication in the US or the Pam 26 publication (Fire Orders and Special Procedures) in the UK). Traditional techniques for conducting these trainings, however, do not interface effectively with simulation backend systems and/or may involve redundancy in personnel.

### BRIEF SUMMARY

Embodiments of the invention(s) described herein are generally related to artillery training and/or operation in military training and/or operational environments, such as tactical engagement simulation (TES) and others. That said, a person of ordinary skill in the art will understand that alternative embodiments may vary from the embodiments discussed herein, and alternative applications may exist (e.g., using weapons other than artillery and/or applications outside of military training and/or operational environments).

In some embodiments, a voice-controlled training unit for conducting fire training and/or operations of an artillery unit may include a communication interface, a memory, and a processing unit communicatively coupled with the communication interface and the memory. The processing unit may be configured to cause the voice-controlled training unit to detect spoken speech, and to determine that the spoken speech includes a command that is related to operation of the artillery unit. The processing unit may be further configured to cause the voice-controlled training unit to generate a message indicative of the command, in accordance with a protocol of a distributed computer simulation standard, and to send, via the communication interface, the message indicative of the command to a remote simulation system.

In some embodiments, a method for conducting fire training and/or operations of an artillery unit may include detecting spoken speech, and determining, by one or more processors, that the spoken speech includes a command that is related to operation of the artillery unit. The method may further include generating, by the one or more processors, a message indicative of the command, in accordance with a protocol of a distributed computer simulation standard. The method may also include sending, via a communication interface, the message indicative of the command to a remote simulation system.

In some embodiments, a non-transitory machine readable medium may include instructions stored thereon for conducting fire training and/or operation of an artillery unit. The instructions may be executable by one or more processors for at least detecting spoken speech and for determining that the spoken speech includes a command that is related to operation of the artillery unit. The instructions may be executable by the one or more processors further for generating a message indicative of the command, in accordance with a protocol of a distributed computer simulation standard, and for sending the message indicative of the command to a remote simulation system.

### BRIEF DESCRIPTION OF THE DRAWINGS

For a more complete understanding of this invention, reference is now made to the following detailed description of the embodiments as illustrated in the accompanying drawings, in which like reference designations represent like features throughout the several views and wherein:

FIG. 1 is a simplified illustration of a training environment, according to an embodiment;

FIG. 2 is a block diagram of various types of electrical components that may be included in a voice-controlled training unit, according to an embodiment.

FIG. 3 is a flow chart of the functionality of a voice-controlled training unit, according to an embodiment; and

FIG. 4 is a flow diagram illustrating a method of conducting fire training and/or operation of an artillery unit, according to an embodiment.

In the appended figures, similar components and/or features may have the same reference label. Further, various components of the same type may be distinguished by following the reference label by a dash and a second label that distinguishes among the similar components. If only the first reference label is used in the specification, the description is applicable to any or all of the similar components having the same first reference label, irrespective of the second reference label.

### DETAILED DESCRIPTION OF THE INVENTION

The ensuing description provides embodiments only, and is not intended to limit the scope, applicability or configuration of the disclosure. Rather, the ensuing description of the embodiments will provide those skilled in the art with an enabling description for implementing an embodiment. It is understood that various changes may be made in the function and arrangement of elements without departing from the scope.

Embodiments provided herein are directed toward including one or more voice-controlled devices (“phonic fires trainers”) in artillery training and/or operation to provide for verbal communication related to training and/or operations of artillery units and/or interface with one or more simulation backend systems that can generate a simulated effect of a verbal artillery command. Different functionality may be implemented depending on the type of training and/or operation, as well as entity at which the voice-controlled device is located.

It can be noted that, although embodiments provided herein describe communications using Long-Term Evolution (LTE) or other cellular technology, other wireless technologies can be used in addition or as an alternative to LTE to communicate with a wide area network (WAN) or other digital communication network. These technologies can include, for example, fifth-generation (5G) New Radio (NR) or Nth Generation (NG) wireless standards and protocols. A person of ordinary skill in the art will appreciate that such standards evolve, and that new equivalent standards may take their place.

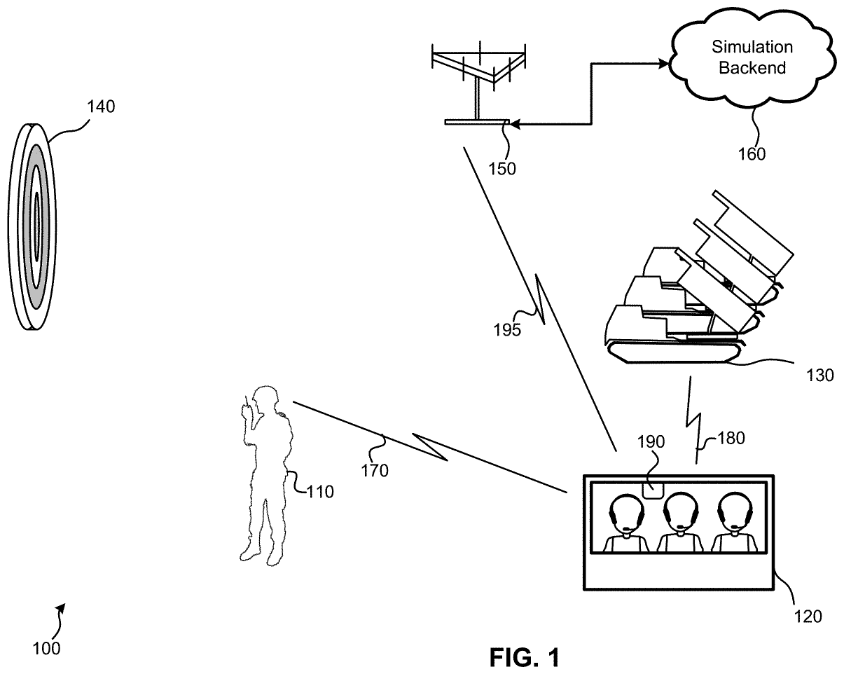

FIG. 1 is a simplified illustration of a training environment 100, according to an embodiment. The training environment 100 (such as a TES environment) may be capable of providing training in a field exercise involving multiple types of entities. These entities may include entities involved in artillery training, such a forward observer 110 (e.g., a Joint Fires Observer (JFO)), command post 120, and artillery units 130. Rather than live ammunition, the training environment 100 may be a “dry” training in which various equipment (such as laser transmitters, for infantry) may be used to simulate the firing of weaponry at a target 140. Moreover, the various entities in the training environment 100 can communicate wirelessly via LTE (or similar wireless technology) to a base station 150, which can communicate between the various entities and a simulation backend 160. Although FIG. 1 illustrates a training environment, some or all of the elements and/or features in the training environment may also be present in an operational environment. Thus, although some of the discussion herein may refer to training related to firing and/or operation of artillery units and/or other weaponry, the various aspects described herein are not intended to be limited to training only; rather, as one skilled in the art would appreciate, the various aspects described herein may also be applicable to operation of artillery units and/or other weaponry in an operational environment.

It can be noted that, to avoid clutter, FIG. 1 illustrates forward observer 110, one command post 120, and a few artillery units 130. However, a person of ordinary skill in the art will appreciate that some embodiments of a training environment 100 may have any number of each entity type (including no entities of a certain type), and may include any number of entities not directly related to artillery training (e.g., infantry, tanks, aircraft, etc.). For example, in a given training, the training environment 100 may comprise dozens, hundreds, or even thousands (or more) of various types of entities. Moreover, embodiments additionally or alternatively may include any number of base stations 150. It can be further noted, however, that although training environment 100 illustrates a field exercise, embodiments of the invention herein may be utilized in other types of training environments, such as classrooms, where the configuration may be significantly different than the training environment 100 illustrated in FIG. 1.

For artillery training in the training environment 100, the forward observer 110 may provide information regarding a target 140 for the artillery units 130 to fire on. This information may include, for example, a location (grid) of the target 140, type of ammunition to be used, and number of rounds. This information can be verbally communicated by the forward observer in accordance with Fire Discipline via radio signals 170 to the command post 120.

The command post 120 may be manned by one or more operators who listen to communications from one or more forward observers 110 and providing corresponding commands to one or more groups of artillery units 130. In FIG. 1, the command post 120 is illustrated as a post physically separate from the artillery units 130. However, in alternative embodiments, the command post may be located anywhere on or off the battlefield, including within the cab of an artillery unit 130 or other vehicle. Additionally or alternatively, there may be one or more sub-command posts (not shown) and/or other entities between the command post 120 and artillery units 130, if desired.

The command post 120 will gather the information regarding the target provided by the forward observer 110 and instruct the artillery units 130 accordingly. For example, operational checks may then be carried-out, meteorology corrections applied, and the firing solution for each artillery unit 130 may be calculated. In some instances, the forward observer 110 may call for an initial firing by a single artillery unit 130, then, if adjustments need to be made, one or more adjustments. Although all of the artillery units 130 may be adjusted during the one or more adjustments, a single artillery unit may be used to make post-adjustment firings to allow the forward observer 110 to see the effect of the adjustment. (Thus, the command post 120 may only need to calculate a firing solution for a single artillery unit 130.) When the impact is sufficiently close to the target, the forward observer 110 may issue the “fire for effect” command, in which case all artillery units 130 may then be fired. Instructions provided by the command post 120 to the artillery units 130 may also be verbal instructions provided in accordance with Fire Discipline and transmitted via radio signals 180 to the command post 120.

The simulation backend 160 may comprise one or more computer servers configured to gather information from the various entities within the training environment 100 to provide real-time simulated effects, data for post hoc After-Action Review (AAR), and/or generate 2D or 3D visualizations of the battlefield. The information gathered from the various entities within the training environment 100 may include, for example, status information (e.g., whether the entity is “killed” or “injured”, location and/or orientation information, etc.), information specific to an entity type (e.g., remaining fuel/ammunition, whether a weapon or equipment is deployed/armed, etc.), engagement information (e.g., whether it has engaged and/or has been engaged by other entities), and the like. The simulation backend 160 may be used to implement TES (from any of a variety of TES providers) and/or other provide 3D rendered visualizations (e.g., of the various entities in the simulation, effects such as the target getting hit, etc.) via a “synthetic wrap” enabling trainees to see the visualizations in properly-equipped displays.

Traditionally, to interface with a simulation backend 160 in a TES exercise, a forward observer 110 would need to radio instructions to a representative supervising the simulation experience, rather than the command post 120. That is, the forward observer 110 would “radio” the representative, who would then enter the information directly into the simulation. Although this would provide a result in the TES environment (e.g., entities within the blast radius would be notified), this does not accurately portray interactions between the forward observer 110 and command post 120 or allow for error and subsequent adjustment.

Additionally, command post training in Fire Discipline where a forward observer 110 and artillery units 130 are not present (e.g., classroom training) is underdeveloped in many ways. It may require multiple people (or one person, pretending to be multiple people) on the other end of a radio, mimicking the response of artillery units 130 to verbal commands provided by the command post. Additionally, there is no interface to a simulation backend, so oftentimes no visualizations (e.g., of “virtual” artillery units 130 responding to commands) are provided to the command post 120 in such trainings.

Embodiments of the invention provided herein address these and other shortcomings of trainings in the classroom, in a training exercise, or in the field, by providing a voice-controlled training unit 190 at one or more locations in training. The voice-controlled training unit 190 (also referred to herein as a “Phonic Fires Trainer”) can receive voice commands and interface with the simulation backend 160 to ensure an appropriate corresponding response in the simulation and/or visualization. In some embodiments, the voice-controlled training unit 190 can further provide a verbal response, enabling verbal training of the forward observer 110, command post 120, and/or artillery units 130. Because many similar or common aspects may be involved and/or present in both training and/or operational environments, the various embodiments of the voice-controlled training unit 190 described herein are not limited to application in training environments only, but may also be applicable in operational environments. Thus, even though some of the embodiments may be described in the context of training, the embodiments described herein may be also applicable to an operational environment, or vice versa, with or without modification, as one of ordinary skill in the art would appreciate.

In some embodiments, in a training exercise, such as the training environment 100 in FIG. 1 where multiple artillery entities 110, 120, 130 are training together, the voice-controlled training unit 190 may be used at one or more locations within the training, depending on desired functionality. In FIG. 1, a voice-controlled training unit 190 is illustrated as being co-located with the command post 120. In alternative embodiments, one or more voice-controlled training units 190 may be additionally or alternatively co-located with the forward observer 110 and/or one or more artillery units 130. As provided in more detail below, the voice-controlled training unit 190 can be used for intercepting verbal communication between the various entities, e.g., forward observer 110, command post 120, and/or artillery units 130. For example, the voice-controlled training unit 190 can be used for (1) intercepting verbal commands between forward observer 110 and command post 120 and communicating with the simulation backend (e.g., via radio signals 195) to help automate corresponding effects in the simulation/visualization, (2) intercepting verbal commands between command post 120 and artillery units 130 and communicating with the simulation backend (e.g., via radio signals 195) to again help automate corresponding effects in the simulation/visualization, (3) providing training of an individual artillery entity 110, 120, 130 by listening verbal commands and providing a verbal and/or non-verbal (e.g., visualization) response, and/or (4) intercepting verbal communication between the entities to facilitate the artillery training and/or operation, and/or providing training and/or operational analytics based on the verbal communication between the various entities.

In some embodiments, in the environment illustrated in FIG. 1, by co-locating the voice-controlled training unit 190 with the command post 120, for example, the voice-controlled training unit 190 may be used to listen to verbal commands spoken by the command post operator(s), e.g., to help automate the resulting effects in the simulation/visualization. For example, if the voice-controlled training unit 190 hears an officer speak a command spoken to an artillery unit 130 in preparation to fire (e.g., “Number 1, bearing 6235 mils, elevation 120 mils, HE PD Charge 4”), the voice-controlled training unit 190 can relay this information to the simulation backend 160, which, for example, may generate a visualization of the artillery unit 130 moving in response to the command, which may be shown to the command post 120 for training purposes. The voice-controlled training unit 190 may further generate a firing solution calculated from abridged firing tables (which may include gathering factors such as meteorological data, barrel wear, charge temperatures, etc.) and, if a “fire” command is subsequently heard, provide the firing solution to the simulation backend 160. In this way, the voice-controlled training unit 190 can help automate responses to commands in the command post 120 by the simulation backend 160 by providing information regarding these commands to the simulation backend 160 via radio signals 195. (It can be noted, however, that in other embodiments, data may be relayed via wired and/or other wireless means, other than radio signals 195.) If desired, a voice-controlled training unit 190 may additionally be co-located with the forward observer 110 and/or artillery units 130 to similarly provide information regarding verbal communication to the simulation backend 160 for an appropriate response in the simulation and/or visualization. For example, in some embodiments, the voice-controlled training unit 190 may also provide the firing solution to the forward observer 110, the command post 120, and/or the artillery units 130 during training and/or operation. The voice-controlled training unit 190 may provide the firing solution to the forward observer 110, the command post 120, and/or the artillery units 130 during the training and/or the operation via an output device, such as a speaker, if the voice-controlled training unit 190 is co-located with the entity. In some embodiments, the voice-controlled training unit 190 may provide the firing solution to the forward observer 110, the command post 120, and/or the artillery units 130 using communication signals, such as radio signals 170, 180, between the entities.

The way in which the voice-controlled training unit 190 and simulation backend 160 communicate may be governed by different relevant standards and/or protocols, which may affect the timing and/or content of the communications. For example, the voice-controlled training unit 190 may be configured to communicate with the simulation backend 160 by formatting data or information to be transmitted in accordance with Distributed Interactive Simulation (DIS), High-Level Architecture (HLA), and/or another distributed computer simulation standard. The voice-controlled training unit 190 may also be configured to communicate with the simulation backend 160 by receiving information in accordance with the the DIS, HLA, and/or another distributed computer simulation standard. As such, the voice-controlled training unit 190 may then be configured to communicate with the simulation backend 160 using a protocol corresponding to the particular computer simulation standard. For example, the voice-controlled training unit 190 may be configured to communicate with the simulation backend 160 using Protocol Data Units (PDUs) when communicating with the backend simulation 160 using the DIS standard. Other embodiments may utilize additional or alternatives protocols and/or standards.

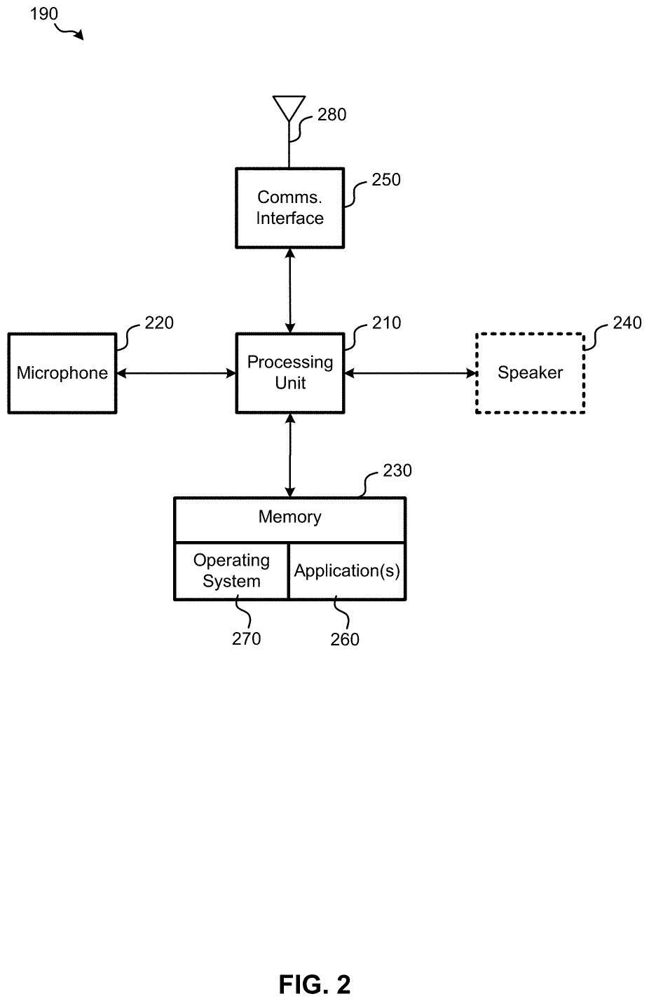

FIG. 2 is a block diagram of various types of electrical components that may be included in the voice-controlled training unit 190, according to an embodiment. Here, the components include a processing unit 210, audio sensor or microphone 220, memory 230, (optional) speaker 240, and communications interface 250. It can be noted that the components illustrated in FIG. 2 are provided as illustrative examples only. Embodiments may have additional or alternative components, may utilize any or all of the illustrated components or other types of components, and/or may utilize multiple components of the same type (e.g., multiple microphones 220 in a microphone array), depending on desired functionality.

Arrows illustrated in FIG. 2 represent communication and/or physical links between the various components. Communication links may be direct (as shown) and/or implemented via a data bus. The voice-controlled training unit 190 may comprise a single, physical unit, in which case the communications may be wired. That said, alternative embodiments may be implemented in a plurality of physical units (e.g., one or more separate housings for one or more microphones 220), in which case some communication links may be wired or wireless. To help ensure security communications, these wireless and/or wired communication links may use one or more types of encryption, which can be made to meet military-grade standards, if required. In some embodiments, the microphone 220 may be attached to and/or otherwise incorporated into a microphone used by the trainee for radio communications.

As discussed in the embodiments above, the voice-controlled training unit 190 may listen for particular verbal communications (e.g., commands and/or responses) and respond accordingly. To implement this functionality, the processing unit 210 may activate the microphone 220 and implement audio processing to scan the audio for certain words and/or phrases (e.g., from Fire Discipline). When these words/phrases are detected, the processing unit 210 can then cause the voice-controlled training unit 190 to provide the correct verbal response and/or simulation response, depending on desired functionality, training mode, and/or other factors. In some embodiments, the processing unit 210 may implement a speech-to-text engine, to allow detected speech to be converted to text for further processing or analysis. Detected speech can be compared, for example, with words and/or phrases in a database of Fire Discipline commands and/or responses (which may be stored in memory 230) to determine whether a proper command or response was given. Because of the limited amount of speech in Fire Discipline, the entire database of Fire Discipline may be stored in the memory 230, and thus speech recognition, too, may be performed locally by the voice-controlled training unit 190. Nonetheless, in some embodiments, speech recognition may additionally or alternatively involve communicating unprocessed and/or pre-processed sounds to a remote server (e.g., via the communications interface) and receiving corresponding text and/or other processed data in return.

In some embodiments, the voice-controlled training unit 190 may also be configured to collect and/or recover metadata from the verbal communications between the entities participating in the training and/or operation. The metadata that may be collected and/or recovered from the verbal communications may include data related to the communications and/or speech, and/or may include data related to the entity creating or conducting the communications. As a few non-limiting examples, the metadata may include speed of the speech, pauses between words and/or sentences, timing, accuracy, clarity, emphasis, tone, volume, language and/or dialects used, identity, gender, and/or age of the speaker, emotional state of the speaker, confidence, hesitation, location of the speaker, etc. In some embodiments, the voice-controlled training unit 190 may include a metadata collecting and/or analyzing module for collecting and/or analyzing the metadata of the verbal communication. In some embodiments, the voice-controlled training unit 190 may additionally or alternatively communicate unprocessed and/or pre-processed sounds to a remote server (e.g., via the communications interface) for metadata collection and/or recovery. The various metadata data collected may be used to provide analytics about each participant of a training and/or operation during or post the training and/or operation.

As discussed above, a verbal response to a verbal command can be provided by the voice-controlled training unit 190 in certain types of training, such as in a classroom environment where radios are not used. In such instances, the processing unit 210 may include a text-to-speech engine allowing the processing unit 210 to provide an appropriate response to a command or other verbal communication provided by a trainee. Responses may be stored in a database and/or provided in accordance with Fire Discipline (or some other applicable protocol). For example, in Fire Discipline, the response to many commands is to simply repeat the command, followed by the word “out.” In such situations, for instance, where the voice-controlled training unit 190 overhears “[spoken command], over,” the voice-controlled training unit 190 can then respond with “[repeat command], out.” The verbal response may first be generated in text, then, using the text-to-speech engine in the processing unit, provided audibly via the speaker 240. In this way, the voice-controlled training unit 190 can be used for verbal training in Fire Discipline (or a similar protocol) by command post operators and/or other artillery entities.

According to some embodiments, the voice-controlled training unit 190 may be additionally configured to operate in different modes, depending on the desired type of training. For example, in a “pedant mode” the voice-controlled training unit 190 may require strict adherence to the verbal protocol of Fire Discipline. In this mode, the voice-controlled training unit 190 may be unresponsive or ask the trainee to repeat the verbal command if the verbal command was spoken incorrectly. The “pedant mode” may be utilized, for example, in classroom training to help the trainee become familiarized with Fire Discipline, getting used to the proper words and reactions. Alternatively, when operating in a “field mode,” the voice-controlled training unit 190 may allow for some error to be allowed where the command is understandable, despite a minor breach in protocol. Such errors could include, for example, relaying data in an incorrect order (e.g., providing an altitude before a grid) or providing an insufficient amount of data (e.g., providing an 8-figure grid rather than a 10-figure grid) and/or other such errors that may replicate conditions in the field. Machine learning and/or similar techniques may be utilized to configure the voice-controlled training unit 190 to allow for such errors.

Depending on the type of training, the voice-controlled training unit 190 may additionally or alternatively provide a simulation response. This can be done, as noted above, by communicating with a simulation backend 160. Thus, when the voice-controlled training unit 190 detects verbal communication (e.g., Fire Discipline commands/responses) that result in an effect in the simulation and/or visualization provided by the simulation backend 160, the voice-controlled training unit 190 can generate a corresponding message (e.g., DIS PDU) and send the message to the simulation backend 160 via the communication interface 250. As noted above, the voice-controlled training unit 190 may be configured to determine a firing solution for one or more artillery units 130 and/or determine other data to provide to the simulation backend 160 in response to certain detected verbal commands.

In some embodiments, the voice-controlled training unit 190 may be configured to maintain a data log in memory 230, which may be used for analytics. For example, a new log may be created for a new training session or field operation conducted, and, depending on desired functionality, various types of data may be stored in the log. As discussed above, metadata of the verbal communication among the various participants in the training and/or operation may be collected. Thus, the log may, for instance, store data to enable the determination of what percentage of voice commands were incorrect, a speed at which voice commands were provided, an emotional state of the speaker, and so forth. According to some embodiments, the voice-controlled training unit 190 may be configured to provide training to multiple trainees (e.g., operators in a command post) simultaneously and/or to intercept communications among multiple participants during training and/or field operation. As such, some embodiments may further provide voice recognition, thereby enabling the voice-controlled training unit 190 to differentiate data from different participants in the training and/or operation (e.g., by tagging log entries with the identity of the participants and/or creating different data logs for different participants) and provide individualized data analytics for training purposes and/or for post-operation review and analysis.

It can be further noted that memory 230 may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, any other physical medium with patterns of holes, a RAM, a PROM, EPROM, a FLASH-EPROM, any other memory chip or cartridge, a carrier wave as described hereinafter, or any other medium from which a computer can read instructions and/or code.

In some embodiments, the functionality of the processing unit 210 described above may be caused by the processing unit 210 executing one or more applications 260, which may be stored in the memory 230. The processing unit 210 may additionally or alternatively execute an operating system 270, such as the Android™ operating system, which also may be stored in the memory 230. The application(s) 260 may therefore be executable for the operating system 270. The processing unit 210 which may comprise without limitation one or more general-purpose processors, one or more special-purpose processors (e.g., application specific integrated circuits (ASICs), and/or the like), reprogrammable circuitry, and/or other processing structure or means, which can be configured to cause the voice-controlled training unit 190 to perform the functionality described herein.

The communications interface 250 can enable communications between the voice-controlled training unit 190 and the other entities within the training environment 100, such as the simulation backend 160, as described above. The communications interface 250 may communicate via an antenna 280 using any of a variety of radio frequency (RF) technologies, such as LTE or other cellular technologies. As such, the communications interface 250 may include any number of hardware and/or software components for wireless communication. Such components may include, for example, a modem, a network card, an infrared communication device, a wireless communication device, and/or a chipset (e.g., components supporting Bluetooth, IEEE 802.11 (including Wi-Fi), IEEE 802.15.4 (including Zigbee), WiMAX™, cellular communication, etc.), and/or the like, which may enable the wireless communication discussed herein. In some embodiments, the communications interface 250 may additionally or alternatively communicate using wired and/or other wireless (e.g., non-RF) technologies.

In some embodiments, the communication interface 250 of the voice-controlled training unit 190 may be configured to detect and/or intercept communication between the various entities participating in the artillery training, such as the verbal communication or spoken speech between the command post 120 and the forward observer 110 and/or the artillery unit 130 communicated via radio signal 170 and/or the radio signal 180. In some embodiments, the radio communication between the various entities participating in the training may be encrypted, such as in accordance with a military grade encryption standard, and the communication interface may be equipped with the capability to decrypt the detected and/or intercepted verbal communication or spoken speech for subsequent processing.

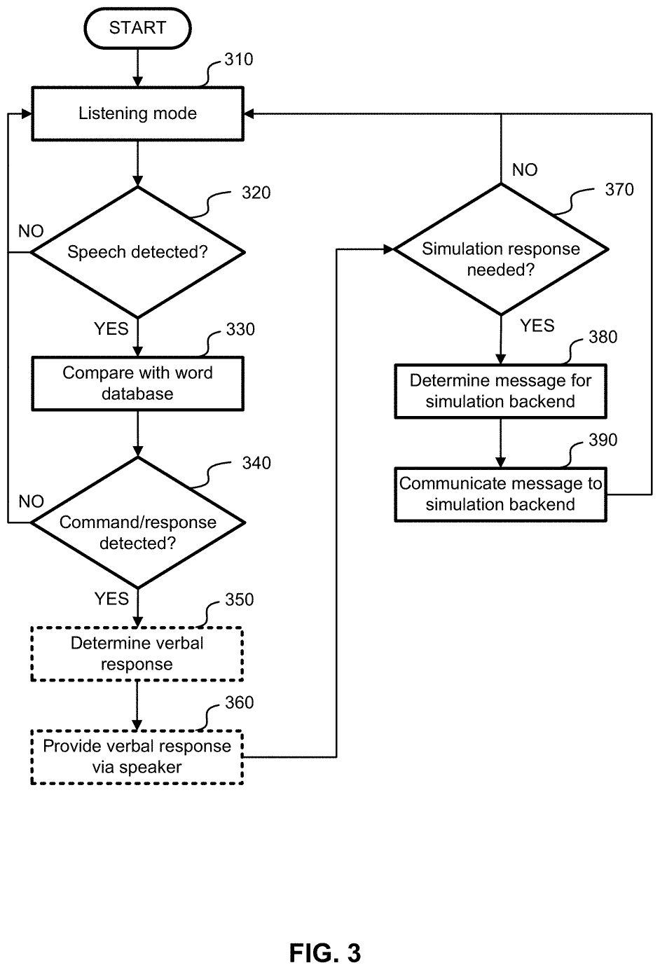

FIG. 3 is a flow chart of the functionality of a voice-controlled training unit 190, according to an embodiment. As such, the functionality of the various blocks within the flow chart may be executed by hardware and/or software components of the voice-controlled training unit 190 as illustrated in FIG. 2. As noted above, in some embodiments, the functionality may be enabled by a processing unit 210 executing one or more software applications 260. It can further be noted that alternative embodiments may alter the functionality illustrated to add, remove, combine, separate, and/or rearrange the various functions shown. As also noted above, although the functionality of the voice-controlled training unit 190 may be described in the context of a training environment, the functionality of the various blocks may also be implemented in an operational environment. A person of ordinary skill in the art will appreciate such variations.

Initially (e.g., when starting a training session) the voice-controlled training unit 190 can enter a “listening” mode, at block 310. Here, as noted above, the voice-controlled training unit 190 may utilize one or more microphones 220 to listen to and process sounds. When sounds are detected, the voice-controlled training unit 190 can then process the sounds to make a determination of whether speech is detected, at block 320. In some embodiments, only sounds having a threshold volume and/or length may be processed for speech. In some embodiments noise filters and/or other audio processing may also be used to further ensure non-speech sounds are ignored. If speech is not detected, the voice-controlled training unit 190 can again return to the listening mode at block 310.

If speech is detected in the sounds, the speech can be compared with a word database, at block 330. As indicated previously, a speech-to-text engine may be used to allow the voice-controlled training unit 190 to convert detected speech to text to determine of the speech is a command or response (e.g., a command or response in Fire Discipline). If a command/response is not detected, the voice-controlled training unit 190 can again enter the listening mode at block 310.

It can be noted that speech-to-text processing is only one method that can be used to determine whether a command/response is detected. Alternative embodiments may, for example combine the detection of sound with the detection of speech, directly mapping certain sounds to certain commands or responses (without separately determining whether a sound was speech). Other embodiments may use other forms of speech recognition. Further, as indicated previously, in addition to detecting the command/response, metadata of the speech may also be collected, including but not limited to, speed of the speech, pauses between words and/or sentences, timing, accuracy, clarity, emphasis, tone, volume, language and/or dialects used, identity, gender, and/or age of the speaker, emotional state of the speaker, confidence, hesitation, location of the speaker, etc. Various speech metadata collection or recovery techniques may be implemented, including but not limited to, emotional recognition based on speech, etc.

If a command/response is detected at block 340, then the voice-controlled training unit 190 can optionally determine whether a verbal response is required at block 350. As noted above, a speaker may be used in some embodiments and/or training modes. In such embodiments and modes, the voice-controlled training unit 190 can then, based on the command/response detected at block 350, determine what an appropriate verbal response would be. As noted herein, a verbal response may be in accordance with Fire Discipline or a similar verbal protocol. In some embodiments, where a certain word or phrase is expected to be followed by additional words or phrases, the voice-controlled training unit 190 can then listen for the additional words or phrases.

Once the verbal response is determined, the voice-controlled training unit 190 can then provide the verbal response via the speaker, at block 360. As noted above, the verbal response may be provided using a text-to-speech engine to generate the appropriate speech from a textual database. In alternative embodiments, the voice-controlled training unit 190 may instead store an audio database in which no text-to-speech conversion may be needed, but a corresponding audio file comprising an appropriate verbal response may be played in response to the command/response detected ab block 360.

At block 370 a determination of whether a simulation response is needed. As previously indicated, some recognized speech may not need a simulation response (e.g., may not result in a simulated effect and/or visualization), in which case the voice-controlled training unit 190 may return to the listening mode at block 310. In cases where a simulation response is needed, however, a message for the simulation backend may then be determined at block 380.

As previously discussed, different commands may result in different simulated effects, and may depend on the type of training. Some training modes may involve a verbal-only training mode in which no simulation response is needed (in which case the voice-controlled training unit 190 would always return to the listening mode at block 310 after providing a verbal response). Other training modes may involve interfacing with a simulation backend 160 running a TES simulation and/or providing 3D visualizations, in which case different commands may results in different messages for the simulation backend 160. As noted above, the voice-controlled training unit 190 may be configured to calculate data (e.g., a firing solution for one or more artillery units 130 based on elevation, azimuth, and charge) and provide that data to the simulation backend 160, which may also include a shell type and/or fuse setting. The timing and content of that data may vary, depending on the type of simulation/visualization provided by the simulation backend 160 (which may be communicated to the voice-controlled training unit 190 by the simulation backend 160 and/or assumed, based on a training mode executed by the voice-controlled training unit 190). At block 390, the voice-controlled training unit 190 then communicates the message to the simulation backend, and the voice-controlled training unit 190 returns to the listening mode at block 310. In some embodiments, even when a simulated effect may not be provided to the participants, such as during a field operation, the message may nonetheless be communicated to the simulation backend 160 for data gathering and/or analysis purposes. For example, the simulation backend 160 may create a simulated effect post operation based on the message received during operation for after-action review and/or for subsequent training purposes.

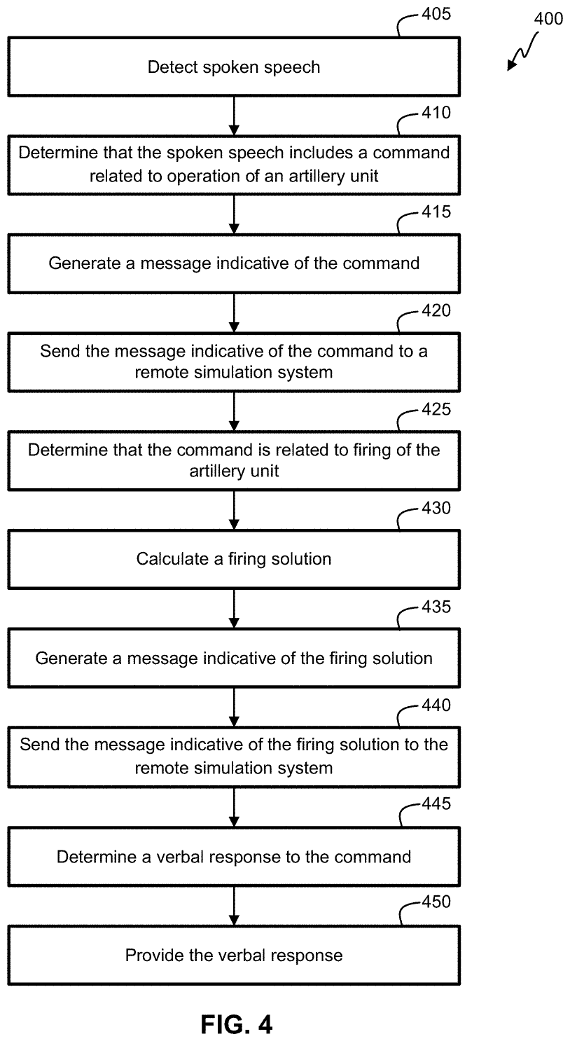

FIG. 4 is a flow diagram illustrating a method 400 of conducting fire training and/or operation of an artillery unit, according to an embodiment. The method 400 can be implemented by the voice-controlled training unit 190 as described herein, for example. As such, means for performing one or more of the functions illustrated in the various blocks of FIG. 4 may comprise hardware and/or software components of the voice-controlled training unit 190. As with other figures herein, FIG. 4 is provided as an example. Other embodiments may vary in functionality from the functionality shown. Variations may include performing additional functions, substituting and/or removing select functions, performing functions in a different order or simultaneously, and the like.

At block 405, the method 400 may include detecting spoken speech. As discussed above, the spoken speech may include verbal communication in accordance with Fire Discipline between various entities participating in a training or field operation involving artillery units, such as forward observers, command post officers, artillery unit operators, etc. In some embodiments, the spoken speech may be detected using an audio sensor, such as the audio sensor or microphone 220 of the voice-controlled training unit 190. In some embodiments, the spoken speech may be detected by detecting spoken speech in wireless communication via a communication interface. For example, the command post officers may communicate verbally with the forward observers and/or the artillery unit operators via radio signals. The communication interface may be configured to detect and/or intercept such verbal communication to detect spoken speech.

At block 410, the method 400 may include determining that the spoken speech includes a command related to operation of an artillery unit. In some embodiments, the detected spoken speech may be converted to text and the converted text may be compared to words, e.g., words and phrases from Fire Discipline, stored in a database. In some embodiments, the detected spoken speech may be mapped or compared to audio information or file to determine whether the detected spoken speech includes a command that is related to operation of an artillery unit. Any of the techniques for determining a command in the spoken speech described herein may be implemented.

At block 415, the method 400 may include generating a message indicative of the command, and at block 420, the message indicative of the command may be sent to a remote simulation system, such as the simulation backend 160 described herein. Communication to and from the remote simulation system may be governed by a protocol of a distributed computer simulation standard and the message may be generated and communicated in accordance with that standard and/or protocol. For example, the message may be generated and/or sent to the remote simulation system using PDUs in accordance with DIS, or any other protocol or standard.

At block 425, in some embodiments, the method 400 may include determining that the command is related to firing of an artillery unit, and at block 430, the method may further include calculating a firing solution for the artillery unit. At block 435, in some embodiments, the method may further include generating a message indicative of the firing solution, and at block 440, the generated message indicative of the firing solution may be sent to the remote simulation system and/or one of the participants of the training or operation. Thus, the message indicative of the firing solution generated at block 435 and the message indicative of the command generated at block 415 may be generated in accordance with the same protocol or standard. In some embodiments, instead of generating another message indicative of the firing solution, the firing solution may be included in the message indicative of the command that is generated at block 415. In other words, the message indicative of the command may also be indicative of the firing solution.

At block 445, in some embodiments, the method 400 may include determining a verbal response to the command detected. For example, when the training is conducted in a classroom setting, an appropriate verbal response may be determined in accordance with Fire Discipline or a similar verbal protocol upon detecting the command. At block 450, the verbal response may then be provided or outputted using an output device, such as a speaker. The verbal response may be provided by converting a text response to a speech using a text-to-speech engine, by playing an audio file stored in a database, etc.

In some embodiments, when multiple participants are involved in the training or operation, method 400 may further include performing voice recognition on the detected spoken speech to differentiate data from different participants. Based on the voice recognition, training and/or operation log entries associated with each participant may be created, e.g., by tagging log entries with the identity of the participant, and individualized data analytics may be provided for each participant. In some embodiments, speech metadata, e.g., speed of the speech, pauses between words and/or sentences, timing, accuracy, clarity, emphasis, tone, volume, language and/or dialects used, identity, gender, and/or age of the speaker, emotional state of the speaker, confidence, hesitation, location of the speaker, etc., may also be collected and stored in the training and/or operation log. Individualized analytics may be generated based on the metadata for each session, and/or for multiple sessions. For example, improvements or the lack thereof over multiple sessions may be observed, and focus of training may be shifted. As another example, performance in a training environment and performance in an operational environment may also be analyzed and/or compared to improve training techniques to better prepare the trainees for field operations.

Various components may be described herein as being “configured” to perform various operations. Those skilled in the art will recognize that, depending on implementation, such configuration can be accomplished through design, setup, placement, interconnection, and/or programming of the particular components and that, again depending on implementation, a configured component might or might not be reconfigurable for a different operation. Moreover, for many functions described herein, specific means have also been described as being capable of performing such functions. It can be understood, however, that functionality is not limited to the means disclosed. A person of ordinary skill in the art will appreciate that alternative means for performing similar functions may additionally or alternatively be used to those means described herein.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

The terms “and,” “or,” and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof

What is claimed is:

1. A voice-controlled training unit for conducting fire training or operations of an artillery unit, the voice-controlled training unit comprising:
a communication interface;
a memory; and
a processing unit communicatively coupled with the communication interface and the memory, and configured to cause the voice-controlled training unit to:
detect spoken speech;
determine that the spoken speech includes a command that is related to operation of the artillery unit;
generate a message indicative of the command, in accordance with a protocol of a distributed computer simulation standard; and
send, via the communication interface, the message indicative of the command to a remote simulation system.

2. The voice-controlled training unit of claim 1, wherein the processing unit is further configured to cause the voice-controlled training unit to:
determine that the command is related to firing of the artillery unit;
calculate a firing solution for the artillery unit;
wherein the processing unit is further configured to cause the voice-controlled training unit to:
generate a message indicative of the firing solution, in accordance with the protocol of the distributed computer simulation standard, and send, via the communication interface, the message indicative of the firing solution to the remote simulation system; or
include, in the message indicative of the command, the firing solution.

3. The voice-controlled training unit of claim 1, further comprising an audio sensor communicatively coupled with the processing unit, wherein the processing unit is further configured to cause the voice-controlled training unit to detect the spoken speech using the audio sensor.

4. The voice-controlled training unit of claim 1, wherein the processing unit is further configured to cause the voice-controlled training unit to:
detect the spoken speech in wireless communication using the communication interface.

5. The voice-controlled training unit of claim 1, wherein the processing unit is further configured to cause the voice-controlled training unit to:
determine that the command results in a simulated effect related to firing of the artillery unit.

6. The voice-controlled training unit of claim 1, further comprising a speaker, wherein the processing unit is further configured to cause the voice-controlled training unit to:
determine a verbal response to the command; and
provide the verbal response using the speaker.

7. The voice-controlled training unit of claim 1, wherein the processing unit is configured to cause the voice-controlled training unit to send the message indicative of the command to the remote simulation system using Protocol Data Units (PDUs) in accordance with a Distributed Interactive Simulation (DIS) standard.

8. The voice-controlled training unit of claim 1, wherein the processing unit is configured to cause the voice-controlled training unit to determine that the spoken speech includes the command related to operation of the artillery unit by converting the spoken speech to text and comparing the text to words of standardized verbal communication for artillery stored in the memory.

9. The voice-controlled training unit of claim 1, wherein the processing unit is further configured to cause the voice-controlled training unit to:
perform voice recognition on the detected spoken speech; and
create training log entries associated with an entity participating in the fire training of the artillery unit based at least in part on the voice recognition.

10. A method for conducting fire training or operations of an artillery unit, the method comprising:
detecting spoken speech;
determining, by one or more processors, that the spoken speech includes a command that is related to operation of the artillery unit;
generating, by the one or more processors, a message indicative of the command, in accordance with a protocol of a distributed computer simulation standard; and
sending, via a communication interface, the message indicative of the command to a remote simulation system.

11. The method of claim 10, further comprising:
determining, by the one or more processors, that the command is related to firing of the artillery unit;
calculating, by the one or more processors, a firing solution for the artillery unit;
generating, by the one or more processors, a message indicative of the firing solution, in accordance with the protocol of the distributed computer simulation standard; and
sending, via the communication interface, the message indicative of the firing solution to the remote simulation system.

12. The method of claim 10, further comprising:
determining, by the one or more processors, that the command is related to firing of the artillery unit;
calculating, by the one or more processors, a firing solution for the artillery unit; and
including, by the one or more processors, the firing solution in the message indicative of the command.

13. The method of claim 10, wherein detecting the spoken speech comprising detecting the spoken speech using an audio sensor or detecting the spoken speech in wireless communication using the communication interface.

14. The method of claim 10, further comprising:
determining, by the one or more processors, that the command results in a simulated effect related to firing of the artillery unit.

15. The method of claim 10, further comprising:
determining, by the one or more processors, a verbal response to the command; and
outputting, via a speaker, the verbal response.

16. The method of claim 10, wherein further comprising collecting metadata related to the detected spoken speech.

17. The method of claim 10, wherein determining that the spoken speech includes the command related to operation of the artillery unit comprises converting the spoken speech to text and comparing the text to words stored in a database.

18. The method of claim 10, further comprising:
performing, by the one or more processors, voice recognition on the detected spoken speech; and
creating, by the one or more processors, training log entries associated with an entity participating in the fire training of the artillery unit based at least in part on the voice recognition.

19. A non-transitory machine readable medium having instructions stored thereon for conducting fire training or operations of an artillery unit, wherein the instructions are executable by one or more processors for at least:
detecting spoken speech;
determining that the spoken speech includes a command that is related to operation of the artillery unit;
generating a message indicative of the command, in accordance with a protocol of a distributed computer simulation standard; and
sending the message indicative of the command to a remote simulation system.

20. The non-transitory machine readable medium of claim 19, wherein the instructions are further executable by the one or more processors for at least:
determining that the command is related to firing of the artillery unit; and
calculating a firing solution for the artillery unit;
wherein the instructions are further executable by the one or more processors for at least:
generating a message indicative of the firing solution, in accordance with the protocol of the distributed computer simulation standard, and sending the message indicative of the firing solution to the remote simulation system; or
including, in the message indicative of the command, the firing solution.
